(19) United States
(12) Patent Application Publication
(10) Pub. No.: US 2026/0352061 A1
(43) Pub. Date: Nov. 5, 2026

(54) ELECTRIC PUMP

(71) Applicant: ZHEJIANG SANHUA AUTOMOTIVE COMPONENTS CO., LTD., Hangzhou, Zhejiang (CN)

(72) Inventors: Jun ZHANG, Hangzhou, Zhejiang (CN); Jundi HU, Hangzhou, Zhejiang (CN); Bingjiu YIN, Hangzhou, Zhejiang (CN)

(73) Assignee: ZHEJIANG SANHUA AUTOMOTIVE COMPONENTS CO., LTD., Hangzhou, Zhejiang (CN)

(21) Appl. No.: 19/486,923

(22) PCT Filed: May 31, 2024
(86) PCT No.: PCT/CN2024/096518

§ 371 Date: Nov. 22, 2025

(30) Foreign Application Priority Data
May 31, 2023 (CN) 202310635677.1

(51) Int. Cl. H02K 5/22; F04D 25/06

(52) U.S. Cl. CPC H02K 5/225; F04D 25/06

(57) ABSTRACT

An electric pump is provided, including a connecting plate assembly. The connecting plate assembly includes a conductive member and an injection molded body; the injection molded body is formed by injection molding with at least part of the conductive member as an insert; the injection molded body includes a limiting member and an insertion connector which are of an integrated structure; the conductive member includes a body portion and pin portions which are fixedly connected or in limited connection; and the connecting positions of the body portion and the pin portions are at least partially located in the injection molded body. According to the electric pump, the deformation of the connecting plate assembly can be reduced.

The present application claims the priority to Chinese Patent Application No. 202310635677.1, titled “ELECTRIC PUMP”, filed with the China National Intellectual Property Administration on May 31, 2023, the entire content of which is incorporated herein by reference.

### FIELD

The present application relates to the technical field of fluid driving, and in particular, to an electric pump.

### BACKGROUND

An electric pump includes a stator winding and a connecting plate assembly. Currently, the connecting plate assembly is limitedly or fixedly mounted on the stator winding. When an assembly formed by fixedly or limitedly mounting the connecting plate assembly on the stator winding is used as an injection molded insert for injection molding, a technical issue to be considered by those skilled in the art is how to reduce the deformation of the connecting plate assembly.

### SUMMARY

An object of the present application is to provide an electric pump, which facilitates reducing the deformation of the connecting plate assembly.

To achieve the above-mentioned object, the following technical solutions are adopted in an embodiment of the present application. An electric pump includes a connecting plate assembly, and the connecting plate assembly includes a conductive member and an injection molded body. The injection molded body is formed by injection molding with at least part of the conductive member as an insert, and the injection molded body includes a limiting member and an insertion connector, which are configured as an integrated structure. The conductive member includes a body portion and a pin portion, the body portion is fixedly or limitedly connected to the pin portion, and a connecting part between the body portion and the pin portion is at least partially located in the injection molded body.

In the technical solution in one embodiment of the present application, the injection molded body is formed by injection molding with at least part of the conductive member as an insert, the limiting member and the insertion connector are configured as an integrated structure, the body portion is fixedly or limitedly connected to the pin portion, and the connecting part between the body portion and the pin portion is located in the injection molded body. In this way, compared with a technical solution in which the body portion and the pin portion are separated structures, it is beneficial to increase the structural strength of the connecting plate assembly, and further reduce the deformation of the connecting plate assembly.

### BRIEF DESCRIPTION OF THE DRAWINGS

FIG. 1 is a schematic perspective structural view of a first embodiment of an electric pump according to present application;

FIG. 2 is a schematic exploded structural view of the electric pump in FIG. 1;

FIG. 3 is a schematic cross-sectional structural view of the electric pump taken along line X-X in FIG. 1;

FIG. 4 is a schematic perspective structural view of an embodiment of a stator winding of the electric pump in FIG. 1;

FIG. 5 is a schematic perspective structural view of a connecting plate assembly in FIG. 1 assembled to the stator winding;

FIG. 6 is a schematic perspective structural view of a first assembly in one direction;

FIG. 7 is a schematic cross-sectional structural view of the first assembly taken along line Y-Y in FIG. 6;

FIG. 8 is a schematic cross-sectional structural view of an embodiment in which a body portion and a pin portion of the connecting plate assembly are separated structures and are electrically connected to each other by plugging;

FIG. 9 is a schematic perspective structural view of a first embodiment of the connecting plate assembly in FIG. 5 in one direction;

FIG. 10 is a schematic perspective structural view of the first embodiment of the connecting plate assembly in FIG. 5 in another direction;

FIG. 11 is a schematic cross-sectional structural view of the connecting plate assembly taken along line Z-Z in FIG. 9;

FIG. 12 is a schematic perspective structural view of a conductive member in the connecting plate assembly in FIG. 11; and

FIG. 13 is a schematic cross-sectional structural view of the connecting plate assembly taken along line W-W in FIG. 9.

### REFERENCE NUMERALS IN THE DRAWINGS

| | | |
|---|---|---|
| 100. electric pump; | 11. pump cover; | 12. rotating assembly; |
| 121. impeller assembly; | 122. rotor assembly; | 13. stator assembly; |
| 131. stator winding; | 1311. stator core; | 1312. insulating frame; |
| 1313. winding; | 132. connecting plate | |
| | assembly; | |
| 135. injection molded body; | 1321. limiting member; | 1321a. pressing portion; |
| 1321b. positioning portion; | 1321c. recess; | 1321d. first part; |
| 1321e. second part; | 1322. conductive member; | 1322a. body portion; |
| 1322f. front side; | 1322g. back side; | 1322b. pin portion; |
| 1322c′. electrical connection | | 1322d. base; |
| portion; | | |
| 1322e. external power supply | | 1323. insertion connector; |
| connection portion; | | |
| 1323a. insertion hole; | 1323d. main body portion; | 1323f. partition; |
| 1324. pressure relief hole; | 1325. abutting portion; | 133. pump shaft; |
| 1331. fixing portion; | 1332. mounting portion; | |
| 134. housing; | 1341. first housing; | 1342. second housing; |
| 141. rotor chamber; | 15. impeller chamber; | 20. pump inner chamber; |
| 21. chamber; | 136. first assembly; | |
| A. connecting part between | | |
| the body portion and the | | |
| pin portion. | | |

### DETAILED DESCRIPTION OF THE EMBODIMENTS

The present application is further illustrated hereinafter in conjunction with accompanying drawings and specific embodiments.

The specific embodiments of the present application are described in detail hereinafter in conjunction with the accompanying drawings. First of all, it should be noted that directional terms such as upper, lower, left, right, front, back, inside, outside, top and bottom mentioned or possibly mentioned in this specification are relative concepts defined based on those constructs shown in the corresponding drawings, and therefore may vary with their locations or use states. Therefore, these and other directional terms should not be construed as restrictive terms.

An electric pump in the following embodiments can provide flow power for a working medium in a vehicle thermal management system. The working medium may be water or an aqueous solution, such as an aqueous solution including 50% ethylene glycol. Of course, the working medium may be other substance.

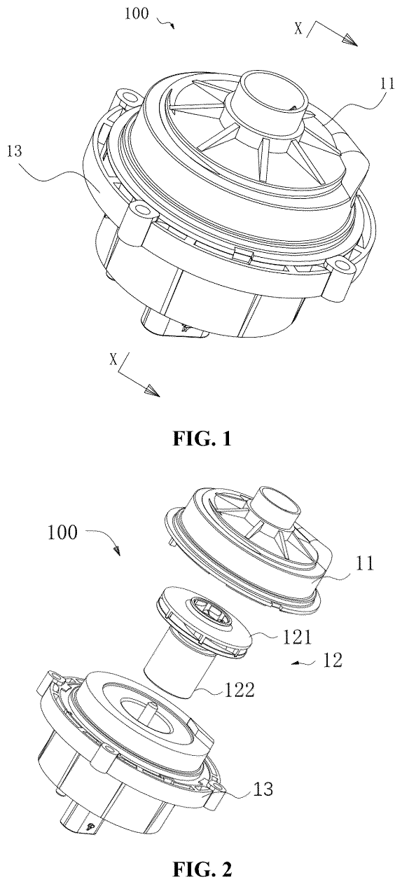

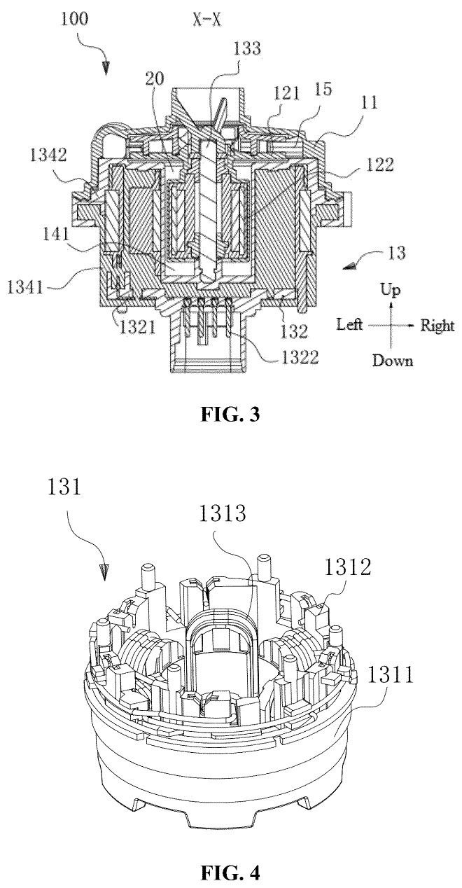

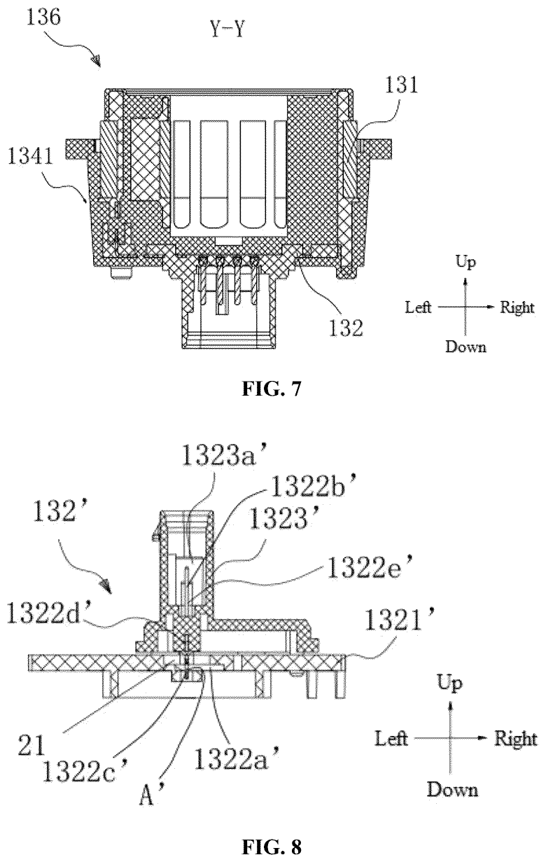

Referring to FIGS. 1 to 7, an electric pump 100 is provided according to the present application, including a pump cover 11, a rotating assembly 12 and a stator assembly 13. The stator assembly 13 includes a connecting plate assembly 132, a stator winding 131, a pump shaft 133 and a housing 134. The housing 134 includes a first housing 1341 and a second housing 1342. The first housing 1341 is formed by injection molding with at least the stator winding 131 as an insert. A first assembly 136 is defined. The first assembly 136 includes the first housing 1341, the stator winding 131 and a connecting plate assembly 132. The second housing 1342 is formed by injection molding with at least the first assembly 136 and the pump shaft 133 as inserts. The first housing 1341 is fixed to the second housing 1342 by injection molding, and the pump cover 11 is sealedly fixed to the stator assembly 13. It should be noted that “sealedly fixed” here means that the working medium is prevented from leaking to the outside of the electric pump when the electric pump is in operation. One end of the pump shaft 133 is fixed to the housing 134 by injection molding. The electric pump 100 has a pump inner chamber 20, and the rotating assembly 16 is located in the pump inner chamber 20. The pump inner chamber 20 includes a rotor chamber 141 and an impeller chamber 15, which are in communication with each other. The rotating assembly 12 includes a rotor assembly 122 and an impeller assembly 121, and the rotor assembly 122 includes a permanent magnet. At least part of the rotor assembly 122 is located in the rotor chamber 141, the impeller assembly 121 is located in the impeller chamber 15, and the working medium may flow through the pump inner chamber 20. In a specific embodiment, the other end of the pump shaft 133 is at least partially located in the rotor chamber 141, at least part of the rotating assembly 12 is sleeved on an outer circumference of the pump shaft 133, and the rotating assembly 12 is in transmission connection with the pump shaft 133. Of course, in another embodiment, the rotating assembly 12 is fixedly connected to the pump shaft 133, and the pump shaft 133 rotates together with the rotor assembly 122. The connecting plate assembly 132 includes an injection molded body 135 and a conductive member 1322, the injection molded body 135 is formed by injection molding with at least part of the conductive member 1322 as an insert, and the injection molded body 135 includes a limiting member 1321 and an insertion connector 1323. The conductive member 1322 includes a first connecting end and a second connecting end. The first connecting end is electrically connected to the stator winding 131, and the second connecting end may be used as a pin end when electrically connected to an external power supply for the electric pump 100. Of course, in another embodiment, the electric pump 100 may not include the pump cover 11. Instead, the pump cover 11 is integrated onto an external structure. With such a configuration, it is more advantageous for the electric pump 100 to have an integrated design to make the structure of the electric pump 100 more compact, which is further advantageous for the miniaturization and lightweight of the structure of the electric pump 100. When the electric pump 100 is in operation, an excitation magnetic field generated by the stator winding 131 is controlled by controlling a current in the stator winding 131, and the rotating assembly 12 rotates around the pump shaft 133 under the action of the excitation magnetic field.

Referring to FIG. 4, the stator winding 131 includes a stator core 1311, an insulating frame 1312 and windings 1313. The number of windings 1313 is at least three. The insulating frame 1312 covers at least part of a surface of the stator core 1311. The insulating frame 1312 is configured to isolate the windings 1313 from the stator core 1311, such that the windings 1313 are electrically insulated and isolated from the stator core 1311. The insulating frame 1312 and the stator core 1311 may be configured as an integrated structure. Specifically, in an embodiment, the insulating frame 1312 is formed by injection molding with the stator core 1311 as an insert. Of course, in another embodiment, the insulating frame 1312 and the stator core 1311 are separately provided. The “separately provided” here means that the insulating frame 1312 and the stator core 1311 are respectively processed into two separate parts and then assembled together. The insulating frame 1312 is limitedly or fixedly connected to the stator core 1311 by means of assembly. In this embodiment, the insulating frame 1312 is formed by injection molding with the stator core 1311 as an insert. It may be understood that the stator core 1311 and the insulating frame 1312 are configured as an integrated structure. The windings 1313 are wound around the insulating frame 1312. In a specific embodiment, the windings 1313 include nine windings. Of course, in another embodiment, the windings 1313 may include other numbers of windings, such as three, six, twelve, or other numbers.

The connecting plate assembly will be described in detail below.

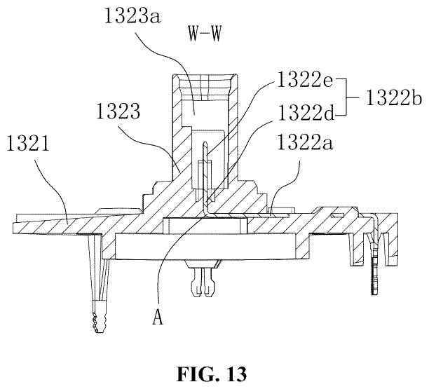

Referring to FIGS. 1 to 13, in an embodiment, the connecting plate assembly 132 is limitedly provided on or fixedly connected to the stator winding 131 in an axial direction of the electric pump 100, and is electrically connected to the windings 1313 of the stator winding 131. The first housing 1341 is formed by injection molding with at least the stator winding 131 and the connecting plate assembly 132 as inserts, and at least part of the connecting plate assembly 132 and part of the stator winding 131 are located within the first housing 1341. In this way, firstly, it facilitates the miniaturization of the electric pump 100 in a radial direction, and secondly, the injection molding with the connecting plate assembly 132 and the stator winding 131 as inserts facilitates simplification of the assembly process of the electric pump 100. For the convenience of subsequent description, the injection molding with the stator winding 131 and the connecting plate assembly 132 as inserts is defined as a first injection molding. It should be noted that the axial direction of the electric pump is the direction in which the pump shaft of the electric pump extends, and the radial direction of the electric pump is perpendicular to the axial direction of the electric pump.

Reference is made to FIG. 8, which shows a structure of the connecting plate assembly. A body portion 1322a′ and a pin portion 1322b′ are separated structures, and the insertion connector 1323′ is limitedly connected to a limiting member 1321′. A pin portion 1322b′ includes an electrical connection portion 1322c′, a base 1322d′ and an external power supply connection portion 1322e′. The electrical connection portion 1322c′ is limitedly connected to the body portion 1322a′, and the base 1322d′ is fixed to the insertion connector 1323′ by injection molding. The external power supply connection portion 1322e′ is configured to be connected to an external power supply, and at least part of the external power supply connection portion 1322e′ is located in an insertion hole 1323a′. In this way, the pin portion 1322b′ is at least partially fixed to the insertion connector 1323′ by injection molding to form an assembly, which is electrically connected to the conductive member embedded in the limiting member 1321′ by plugging, thereby facilitating the increase of the adaptability of the connecting plate assembly 132′. That is to say, the assembly formed by the pin portion 1322b′ at least partially fixed to the insertion connector 1323′ by injection molding may be used in electric pumps of different models, which facilitates reducing a production cost of the electric pump. Since the body portion 1322a′ and the pin portion 1322b′ are separated structures, part of the body portion 1322a′ is located in the limiting member 1321′, and part of the pin portion 1322b′ is located in the insertion connector 1323′. The pin portion 1322b′ is electrically connected to the body portion 1322a′ by plugging. With such connection, the connecting part A′ between the body portion 1322a′ and the pin portion 1322b′ is not covered by an injection molded body, and a chamber 21 is formed above the body portion 1322a′ and the pin portion 1322b′, specifically as shown in FIG. 8. During the first injection molding, due to the existence of the chamber 21, an externally applied force cannot directly act on the body portion 1322a′. It may be understood that in the presence of the chamber 21, when the connecting plate assembly is filled with injection molding material during the injection molding process, the conductive member is deformed under the action of an injection molding pressure, which may cause an electrical failure of the connecting plate assembly 132′.

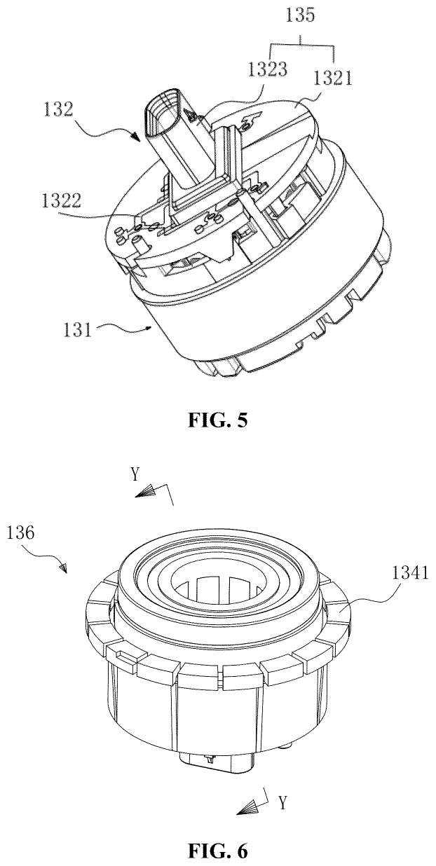

In an embodiment, referring to FIGS. 5 to 7 and FIGS. 9 to 13, the connecting plate assembly 132 includes an injection molded body 135 and a conductive member 1322. The injection molded body 135 is formed by injection molding with part of the conductive member 1322 as an insert, and the injection molded body 135 includes a limiting member 1321 and an insertion connector 1323. Specifically, the limiting member 1321 and the insertion connector 1323 are injection molded parts, and the conductive member 1322 is a metal part. The conductive member 1322 includes a body portion 1322a and a pin portion 1322b. The body portion 1322a is fixedly or limitedly connected to the pin portion 1322b. Specifically, the body portion 1322a and the pin portion 1322b may be separated structures, and they are fixedly connected to each other by welding or electrically connected to each other by plugging. The electric pump 100 includes a contact pin (not shown in the figures), and the contact pin and the conductive member 1322 may be configured as an integrated structure or separated structures. An end of the contact pin is electrically connected to a terminal end of the stator winding 131, and the other end of the contact pin is fixedly connected to the body portion. The insertion connector 1323 is limitedly or fixedly connected to the limiting member 1321. The insertion connector 1323 is provided with an insertion hole 1323a, at least part of the body portion 1322a is embedded in the limiting member 1321, at least part of the pin portion 1322b is located in the insertion hole 1323a, and the connecting part A between the body portion 1322a and the pin portion 1322b is at least partially located in the injection molded body. In a specific embodiment, the connecting part A between the body portion 1322a and the pin portion 1322b is entirely located in the injection molded body. In this way, compared with a technical solution in which the body portion and the pin portion are separated structures, the chamber formed due to the plug-in electrical connection between the separately structured body portion 1322a and pin portion 1322b can be minimized, which facilitates increasing the structural strength of the connecting plate assembly 132, and thereby reducing the deformation of the connecting plate assembly 132.

In order to reduce the deformation of the connecting plate assembly 132 during the first injection molding, referring to FIGS. 6, 7, 11, 12, and 13, the connecting plate assembly 132 includes an injection molded body 135 and a conductive member 1322. The injection molded body 135 is formed by injection molding with at least part of the conductive member 1322 as an insert, and the injection molded body 135 includes a limiting member 1321 and an insertion connector 1323, which are configured as an integrated structure. The conductive member 1322 includes a body portion 1322a and a pin portion 1322b, which are configured as an integrated structure, and the connecting part between the body portion 1322a and the pin portion 1322b is located in the injection molded body 135, at least part of the body portion 1322a is located in the limiting member 1321, and at least part of the pin portion 1322b is embedded in the insertion connector 1323. In this way, the chamber formed due to the plug-in electrical connection between the separately structured body portion part 1322a and pin portion 1322b can be minimized, which facilitates increasing the structural strength of the connecting plate assembly. As a result, during the first injection molding, an external force may directly act on the limiting member 1321, which facilitates reducing the deformation of the connecting plate assembly 132 during the first injection molding, and reducing the electrical failure of the connecting plate assembly 132.

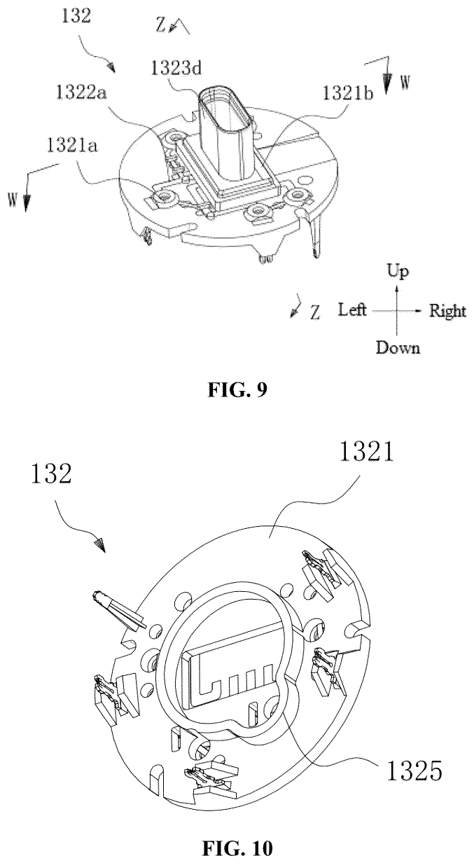

In an embodiment, referring to FIGS. 9 to 13, during the first injection molding, the connecting plate assembly 132 includes a positioning portion 1321b for adding action points of the external force. The positioning portion 1321b is fixed on a radial outer side of the insertion connector 1323 by injection molding in the radial direction of the electric pump, and a lower surface of the positioning portion 1321b is fixed to an upper surface of the limiting member 1321 by injection molding. In this way, the positioning portion 1323 may be used as another action point of the external force during the first injection molding, and may be pressed against the connecting plate assembly 132 to reduce the deformation of the connecting plate assembly 132 under the action of the injection molding pressure. In this way, on the one hand, the structural strength of the connecting plate assembly 132 may be increased by the positioning portion 1321b, and on the other hand, the positioning portion 1321b may be used as a supporting part for the action point of the external force. Thus, the deformation of the connecting plate assembly 132 during the first injection molding can be further reduced.

Further, referring to FIGS. 9 to 13, the positioning portion 1321b mentioned above may also be used as a positioning reference for closing an upper mold and a lower mold in the first injection molding, which provides a certain foundation for simplifying the mold structure used in the first injection molding. In an embodiment, the positioning portion 1321b includes a first part 1321d and a second part 1321e. The first part 1321d is closer to the insertion connector 1323 than the second part 1321e in a direction perpendicular to a thickness of the limiting member 1321. When the first part 1321d and the second part 1321e are projected onto a direction where the upper surface of the limiting member 1321 is located, along a direction parallel to a thickness direction of the limiting member 1321, a projection of the first part 1321d is located within a projection of the second part 1321e. In this way, the first part 1321d may be used as a positioning reference for the mold used in the first injection molding, and an upper surface of the second part 1321e may be used as a supporting part for the action point of the external force. As a result, this not only reduces the deformation of the connecting plate assembly 132 during the first injection molding, but also facilitates the simplification of the mold structure used in the first injection molding, providing a certain foundation for reducing the production cost of the electric pump. It should be noted that the “thickness direction of the limiting member” mentioned here and below refers to a direction from the upper surface of the limiting member towards a lower surface of the limiting member, or a direction from the lower surface of the limiting member towards the upper surface of the limiting member.

In an embodiment, referring to FIGS. 1 to 7 and FIGS. 9 to 13, the connecting plate assembly 132 includes an abutting portion 1325, which protrudes from the lower surface of the limiting member 1321 in a direction far away from the lower surface of the limiting member 1321, and the abutting portion 1325 abuts against the stator winding 131. In this way, the abutting portion 1325 abuts against the stator winding 131, and the abutting portion 1325 is fixedly connected to the limiting member 1321. During the first injection molding, the stator winding 131 is used as a positioning reference, because the abutting portion 1325 directly abuts against the stator winding 131, specifically the abutting portion 1325 abuts against the insulating frame of the stator winding 131, and more specifically, the abutting portion 1325 abuts against the insulating frame 1312 on an upper part of a boot of the stator winding 131. In this way, the abutting portion 1325 may provide a certain supporting force for the lower surface of the limiting member 1321, so that a larger force may be applied to the connecting plate assembly 132 to balance the injection molding pressure during the first injection molding, which facilitates reducing the deformation of the connecting plate assembly 132 during the first injection molding.

In an embodiment, referring to FIGS. 9 to 13, the abutting portion 1325 is an annular structure, and the positioning portion 1321b is a rectangular structure. When the abutting portion 1325 and the positioning portion 1321b are projected onto a plane where the upper surface of the limiting member 1321 is located, along a direction parallel to a thickness direction of the limiting member 1321, at least part of a projection of the positioning portion 1321b is located within a projection of the abutting portion 1325. In this way, an external force acting on the positioning portion 1321b is located within a supporting area of the abutting portion 1325, which facilitates reducing the influence of the external force on the connecting plate assembly and reducing the deformation of the connecting plate assembly.

More specifically, an upper surface of the second part 1321e is disposed close to the abutting portion 1325 in the radial direction of the electric pump. When an external force acts on the upper surface of the limiting member, an acting point of the external force is within a supporting area of the annular abutting portion 1325, and the upper surface of the second part 1321e is close to the abutting portion 1325 in the radial direction of the electric pump. In this way, it is beneficial to reduce the deformation of the connecting plate assembly 132 during the first injection molding.

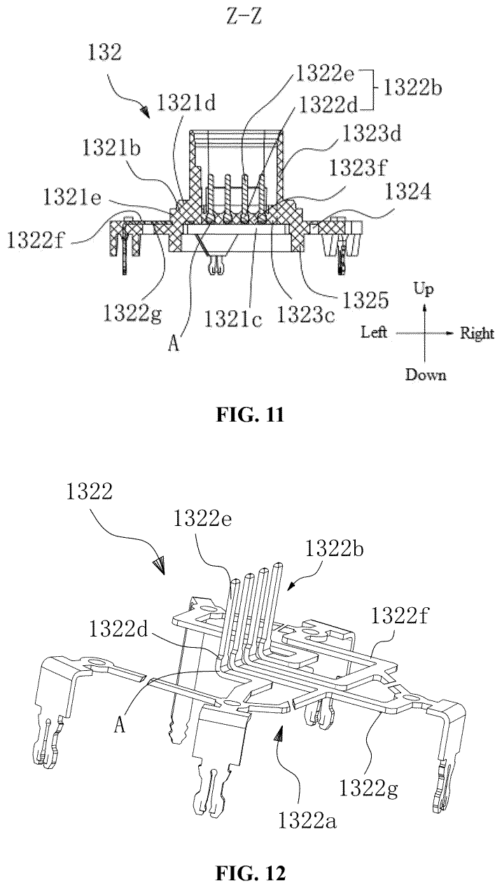

In an embodiment, referring to FIG. 11, the connecting plate assembly 132 further includes a pressure relief hole 1324, which extends through the limiting member 1321 in the thickness direction of the limiting member 1321. The pressure relief hole 1324 may reduce a force exerted by the injection molding pressure on the connecting plate assembly 132 during the first injection molding, which facilitates reducing the deformation of the connecting plate assembly 132 during the first injection molding.

In an embodiment, referring to FIGS. 9 to 11, the pin portion 1322b includes a base 1322d and an external power supply connection portion 1322e. The insertion connector 1323 includes a main body portion 1323d, which is provided with an insertion hole 1323a. A wall portion corresponding to the insertion hole 1323a includes a partition 1323f. The base 1322d is located in the partition 1323f, and at least part of the external power supply connection portion 1322e is located in the insertion hole 1323a. In this way, while achieving the fixation of the pin portion 1322b, it is beneficial to reduce the thickness of the injection molded body of the connecting plate assembly 132, providing a certain foundation for the uniformity of a wall thickness of the connecting plate assembly 132.

The body portion 1322a may be embedded in the upper surface of the limiting member 1321, or may be embedded in the lower surface of the limiting member 1321. In an embodiment, referring to FIGS. 9 to 13, the body portion 1322a includes a front side 1322f and a back side 1322g. The front side 1322f is closer to the insertion connector 1323 than the back side 1322g in a direction perpendicular to a thickness direction of the limiting member 1321, the back side 1322g is embedded in the limiting member 1321, and at least part of the front side 1322f is not covered by the limiting member 1321. In this way, the part of the front side 1322f not covered by the limiting member 1321 may be used as a positioning reference during the injection molding process of the conductive member 1322. Thereby, it is beneficial to simplify the mold structure for the injection molding of the connecting plate assembly 132, providing a certain foundation for reducing the production cost of the electric pump.

Referring to FIGS. 9 to 11, at least part of the front side 1322f is not covered by the limiting member 1321. In an embodiment, in order to increase the connection strength between the body portion 1322a and the limiting member 1321 and reduce the possibility that the part of the body portion 1322a is separated from the limiting member 1321, the connecting plate assembly 132 includes a pressing portion 1321a, which protrudes in a direction from the upper surface of the limiting member 1321 to the insertion connector 1323. The pressing portion 1321a is fixed to the limiting member 1321 by injection molding, and part of an upper surface of the body portion 1322a is in contact with the pressing portion 1321a. In this way, the front side 1322f of the body portion 1322a that is not covered by the limiting member 1321 may be fixed, which facilitates reducing the possibility that the body portion 1322a is separated from the limiting member 1321.

In an embodiment, referring to FIG. 11, the limiting member 1321 includes a recess 1321c, which is recessed in a direction from the lower surface of the limiting member 1321 to the upper surface of the limiting member 1321, and the recess 1321c is arranged close to an axis of the limiting member 1321. In this way, it is more beneficial for the uniformity in a wall thickness of the injection molded body of the connecting plate assembly 132.

In an embodiment, referring to FIGS. 1 to 13, the material of the limiting member 1321 includes a thermoplastic engineering plastic, which includes Phenylenesulfide (PPS). A melting point of the material of the limiting member 1321 is higher than or equal to that of the Phenylenesulfide. In this way, it is beneficial to increase a temperature resistance of the injection molding material of the limiting member, providing a certain foundation for reducing the softening and deformation of the connecting plate assembly 132 during the first injection molding.

It should be noted that, the above embodiments are only intended to illustrate the present application rather than to limit the technical solutions described in the present application. Although the present specification has been described in detail with reference to the embodiments as described above, it should be understood by those skilled in the art that modifications or equivalent substitutions may still be made by those skilled in the art to the present application, and all technical solutions and improvements thereof that do not depart from the spirit and scope of the present application shall be included within the scope of the claims of the present application.

1. An electric pump, comprising a connecting plate assembly, wherein the connecting plate assembly comprises a conductive member and an injection molded body; and wherein
the injection molded body is formed by injection molding with at least part of the conductive member as an insert, and the injection molded body comprises a limiting member and an insertion connector, which are configured as an integrated structure;
the conductive member comprises a body portion and a pin portion, the body portion is fixedly or limitedly connected to the pin portion, and a connecting part between the body portion and the pin portion is at least partially located in the injection molded body.

2. The electric pump according to claim 1, wherein the pin portion comprises a base and an external power supply connection portion, the insertion connector comprises a main body portion, which is provided with an insertion hole, a wall portion corresponding to the insertion hole comprises a partition, the base is located in the partition, and at least part of the external power supply connection portion is located in the insertion hole.

3. The electric pump according to claim 1, wherein the connecting plate assembly comprises a positioning portion, which is fixed on a radial outer side of the main body portion by injection molding in a radial direction of the electric pump, and a lower surface of the positioning portion is fixed to an upper surface of the limiting member by injection molding.

4. The electric pump according to claim 2, wherein the connecting plate assembly comprises a positioning portion, which is fixed on a radial outer side of the main body portion by injection molding in a radial direction of the electric pump, and a lower surface of the positioning portion is fixed to an upper surface of the limiting member by injection molding.

5. The electric pump according to claim 3, wherein the positioning portion comprises a first part and a second part, the first part is closer to the main body portion than the second part in a direction perpendicular to a thickness direction of the limiting member, and when the first part and the second part are projected onto a plane where the upper surface of the limiting member is located, along a direction parallel to the thickness direction of the limiting member, a projection of the first part is located within a projection of the second part.

6. The electric pump according to claim 4, wherein the positioning portion comprises a first part and a second part, the first part is closer to the main body portion than the second part in a direction perpendicular to a thickness direction of the limiting member, and when the first part and the second part are projected onto a plane where the upper surface of the limiting member is located, along a direction parallel to the thickness direction of the limiting member, a projection of the first part is located within a projection of the second part.

7. The electric pump according to claim 1, wherein the electric pump comprises a stator winding, the connecting plate assembly comprises an abutting portion, and wherein
the abutting portion protrudes from a lower surface of the limiting member in a direction far away from the lower surface of the limiting member, and the abutting portion abuts against the stator winding.

8. The electric pump according to claim 2, wherein the electric pump comprises a stator winding, the connecting plate assembly comprises an abutting portion, and wherein
the abutting portion protrudes from a lower surface of the limiting member in a direction far away from the lower surface of the limiting member, and the abutting portion abuts against the stator winding.

9. The electric pump according to claim 3, wherein the electric pump comprises a stator winding, the connecting plate assembly comprises an abutting portion, and wherein
the abutting portion protrudes from the lower surface of the limiting member in a direction far away from the lower surface of the limiting member, and the abutting portion abuts against the stator winding.

10. The electric pump according to claim 4, wherein the electric pump comprises a stator winding, the connecting plate assembly comprises an abutting portion, and wherein
the abutting portion protrudes from the lower surface of the limiting member in a direction far away from the lower surface of the limiting member, and the abutting portion abuts against the stator winding.

11. The electric pump according to claim 7, wherein the abutting portion is an annular structure, the positioning portion is a rectangular structure, and when the abutting portion and the positioning portion are projected onto a plane where an upper surface of the limiting member is located, along a direction parallel to a thickness direction of the limiting member, at least part of a projection of the positioning portion is located within a projection of the abutting portion.

12. The electric pump according to claim 1, wherein the body portion comprises a front side and a back side, the front side is closer to the insertion connector than the back side in a direction parallel to a thickness direction of the limiting member, the back side abuts against the limiting member, and at least part of the front side is not covered by the limiting member.

13. The electric pump according to claim 12, wherein the connecting plate assembly comprises a pressing portion, which protrudes in a direction from an upper surface of the limiting member to the insertion connector, the pressing portion is fixed to the limiting member by injection molding, and a part of an upper surface of the body portion is in contact with the pressing portion.

14. The electric pump according to claim 1, wherein the limiting member comprises a recess, which is recessed in a direction from a lower surface of the limiting member to an upper surface of the limiting member, and a wall portion corresponding to the recess comprises a part of the body portion.

15. The electric pump according to claim 1, wherein a material of the limiting member has a melting point greater than or equal to that of the Phenylenesulfide.

16. The electric pump according to claim 2, wherein the body portion comprises a front side and a back side, the front side is closer to the insertion connector than the back side in a direction parallel to a thickness direction of the limiting member, the back side abuts against the limiting member, and at least part of the front side is not covered by the limiting member.

17. The electric pump according to claim 3, wherein the body portion comprises a front side and a back side, the front side is closer to the insertion connector than the back side in a direction parallel to a thickness direction of the limiting member, the back side abuts against the limiting member, and at least part of the front side is not covered by the limiting member.

18. The electric pump according to claim 4, wherein the body portion comprises a front side and a back side, the front side is closer to the insertion connector than the back side in a direction parallel to a thickness direction of the limiting member, the back side abuts against the limiting member, and at least part of the front side is not covered by the limiting member.

19. The electric pump according to claim 5, wherein the body portion comprises a front side and a back side, the front side is closer to the insertion connector than the back side in a direction parallel to a thickness direction of the limiting member, the back side abuts against the limiting member, and at least part of the front side is not covered by the limiting member.

20. The electric pump according to claim 6, wherein the body portion comprises a front side and a back side, the front side is closer to the insertion connector than the back side in a direction parallel to a thickness direction of the limiting member, the back side abuts against the limiting member, and at least part of the front side is not covered by the limiting member.
